(19) United States
(12) Patent Application Publication
(10) Pub. No.: US 2009/0160722 A1
(43) Pub. Date: Jun. 25, 2009

(54) Antenna formed of multiple loops

(76) Inventors: Mark Rhodes, West Lothian (GB); Brendan Hyland, Edinburgh (GB)

Correspondence Address: Goodwin Procter LLP;Attn: Patent Administrator, 135 Commonwealth Drive, Menlo Park, CA, 94025-1105, US

(21) Appl. No.: 12/329,097

(22) Filed: Dec. 5, 2008

Related U.S. Application Data
(60) Provisional application No. 61/014,787, filed on Dec. 19, 2007.

(30) Foreign Application Priority Data
Dec. 19, 2007 (GB) 0724697.8

(51) Int. Cl. H01Q 7/08

(52) U.S. Cl. 343/788

(57) ABSTRACT

A magnetic and/or magneto-electric antenna is provided that has a plurality of conducting loops. Two or more of the loops are driven by separate drivers.

### CROSS-REFERENCE TO RELATED APPLICATIONS

This application claims the benefit of U.S. Ser. No. 61/014,787 filed Dec. 19, 2007, GB Ser. No. 0724697.8 filed Dec. 19, 2007, and GB 0817176.1 filed Dec. 19, 2008 all of which applications are fully incorporated herein by reference.

### INTRODUCTION

The present invention relates to electromagnetic and/or magneto-inductive antennas.

### BACKGROUND

FIG. 1 shows a magnetic loop antenna that has a single magnetic loop 1 connected to a single drive circuit 2. The output signal from driver 2 may be derived from an input from signal source 3, the characteristics of which are appropriate to the system and antenna of which it is a part. For such a loop antenna, which has known dimensions and number of turns and is driven by an alternating voltage of a known frequency, there will be some maximum drive voltage that cannot be exceeded for practical reasons. Consequently, due to the particular inductive reactance of the loop, there will be some corresponding resultant maximum loop current.

Magnetic loop antennas can be used in a number of applications, but are particularly useful in underwater electromagnetic and/or magneto-inductive communications systems where relatively low signal frequencies are needed to reduce signal attenuation. Such magnetic loops generate an alternating magnetic field. The strength of the magnetic field is commonly defined by the magnetic moment. The magnetic moment is directly proportional to each of three parameters: loop area, loop current, and number of loop turns. Equivalently, it may be stated that the magnetic moment is proportional to both the ampere-turn product of the loop and to the area of the loop. For signal detection at greatest distance, the largest achievable magnetic moment is desirable. Thus, it is usually desirable that as many as possible of the three partially related parameters are designed to be as large as practical circumstances will permit.

In arranging to achieve a large magnetic moment, particular antenna and transmitter system designs may be constrained in practice by, for example: the practical maximum size (usually diameter) of antenna loop; the inductive reactance of the loop, which at a particular frequency is determined principally by the number of turns and the diameter; and the maximum drive voltage. The otherwise desirable goals of a large number of turns and of a large diameter both have the effect of increasing the inductance of the loop. Any given alternating drive voltage will result in current in the loop inversely proportional to the inductance assuming the loop resistance is small. Thus, the desirable effects resulting from a larger area of loop and more turns tend to be counteracted by a lesser loop current due to increased inductive reactance. Whilst using a larger voltage can increase the drive current, there are practical limits to the drive voltage that may be used.

### SUMMARY

According to the present invention there is provided a magnetic and/or magneto-electric antenna that has a plurality of conducting loops driven by separate drivers.

Every loop may be driven by a separate driver. Alternatively, one or more groups of loops may be driven by separate drivers.

Each loop may be centred about a common axis, and displaced along that axis.

The loops may be used singly or in combination to receive a signal.

The signals received from each loop may be combined substantially in phase.

The conductor loops may be in close proximity and/or closely coupled.

The loops may be used singly or in combination to transmit signal currents. The transmit signal in each loop may be arranged to be substantially in phase mutually.

The output of one or more of the driver circuits may be electrical voltage.

The output of one or more driver circuit may be an electrical current.

One or more of the driver circuits may have an impedance that has real and/or imaginary parts.

An antenna may be incorporated in a communications system or a navigation system or a direction finding system or a system for detecting the presence of objects or any combination of these.

### BRIEF DESCRIPTION OF THE DRAWINGS

Various aspects of the invention will now be described by way of example only and with reference to the accompanying drawings, of which:

FIG. 1 shows a conventionally driven loop that does not benefit from the arrangement described in this invention;

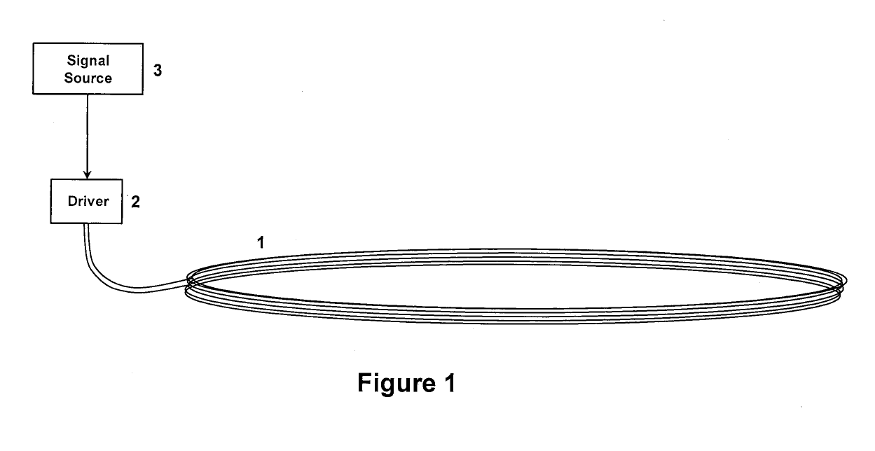

FIG. 2 is an example of a modified circular loop antenna which has a number of sub-loops each driven by a separate drive circuit;

FIG. 3 shows a system of multiple antennas, each driven by a separate driver amplifier and

FIG. 4 shows a system of multiple antennas, each connected to a receive amplifier.

### DETAILED DESCRIPTION OF THE DRAWINGS

The present invention relates to magnetic and/or magneto-inductive loop antennas in which the effective conductive loop is divided into two or more loops, and separate drive circuits are used to drive the current in individual loops. In one example, a loop antenna formed by (say) N₁ turns of a conductor is divided into a number of separate sub-loops, each comprising a proportion of the original N₁ turns. For convenience, it is assumed that the original N₁ turns are divided into 10 lesser sub-loops each with N₁/10 turns. A separate driver circuit drives each of the ten sub-loops. The alternating signals from all of the driver circuits are arranged to be substantially and mutually in phase. Thus, the corresponding ten currents (I₁) and resultant contributions to the combined magnetic flux are also in phase. In this particular arrangement, because of complete mutual coupling, each sub-loop couples not just the flux it would create independently, but the flux of the entire group. However, each sub-loop now has a reduced number of turns (N₁/10). If each drive circuit is the same as that used to drive an N₁ turn loop, and has sufficient signal current capacity, the current caused to flow in each of the sub-loops will now be ten times greater than for that of a ten turn loop with a single drive.

This can be understood from the conventional expression for inductance (L) namely: L=NΦ/I, where N is the number of turns coupled by the flux Φ, and I is the current in the inductor. Inductance L for an antenna with ten turns, each with its own separate drive, is a factor of 10 lower than for a corresponding loop structure, but with a single current drive. Provided the currents are all in phase, this arises due to a reduction of N by a factor of 10, and an increase in both Φ and I by factors of 10. The reduced inductance, and hence inductive reactance, seen by each drive circuit is one tenth of that seen by the original drive circuit, so that ten times the original alternating current flows in each sub-loop. As a result the magnetic moment of the combined set of sub-loops driven with separate drive circuits is ten times greater than before. Moreover, in this example, the larger magnetic moment may be achieved without requiring greater drive voltage.

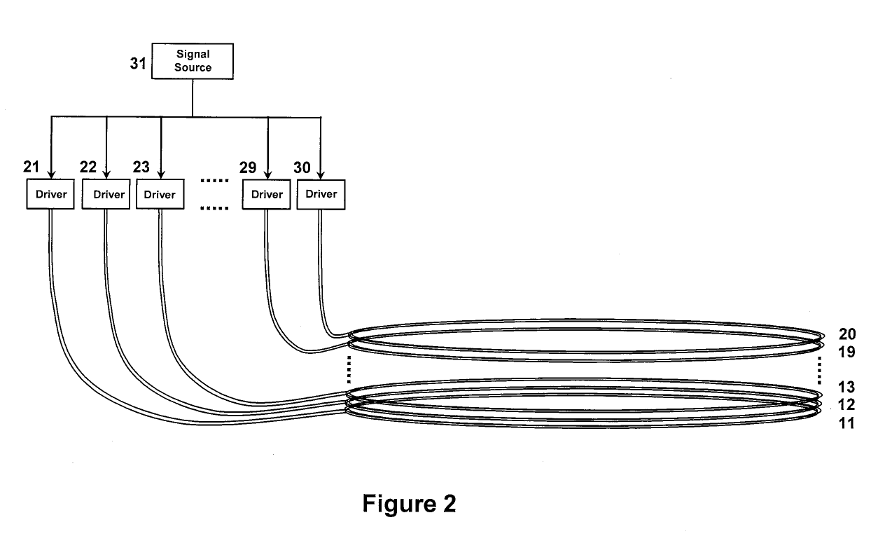

FIG. 2 shows a composite antenna loop comprised of several sub-loops. In this example, there are ten sub-loops, of which only five sub-loops 11, 12, 13 . . . 19, 20 are shown for simplicity. Although shown spatially separated somewhat for clarity, it is advantageous if the ten sub-loops 11 to 20 are situated in close proximity and with similar axes so that the antennas are all coupled. Each sub-loop has its own corresponding driver, of which only five drivers 21, 22, 23 . . . 29, 30 are shown for simplicity. For optimum performance, the ten drivers 21 to 30 should provide signal currents in their corresponding sub-loops substantially in phase with each other. This is easily achieved if the drivers are nominally identical and all supplied from the same common signal source 31. By using multiple sub-loops with separate drive circuits the magnetic moment of a loop antenna can be increased without need for greater drive voltage.

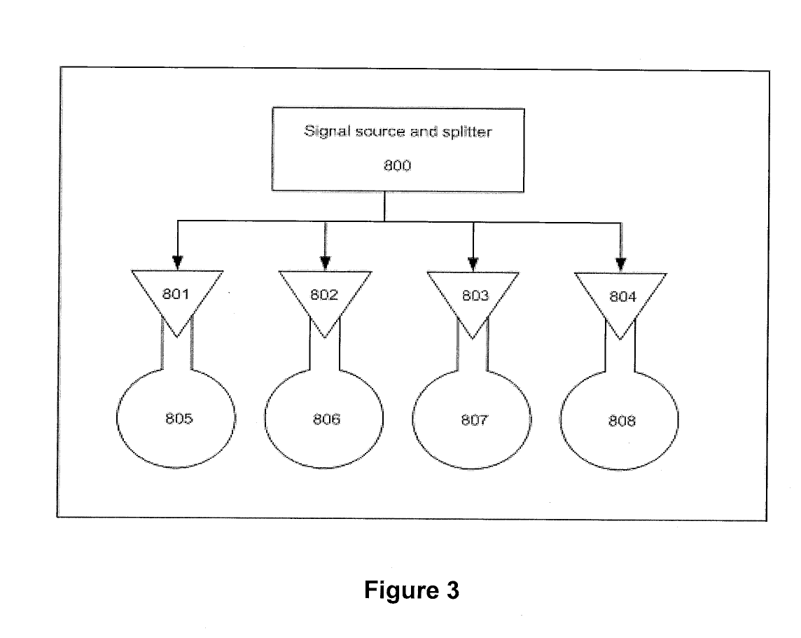

FIG. 3 shows a system of multiple antennas 805, 806, 807 and 808 each driven by a separate driver amplifier 801, 802, 803 and 804 illustrated in schematic form. A common signal source is divided by splitter 800 to feed each transmit amplifier. This system can be used to drive any of the multiple antenna systems described in this application.

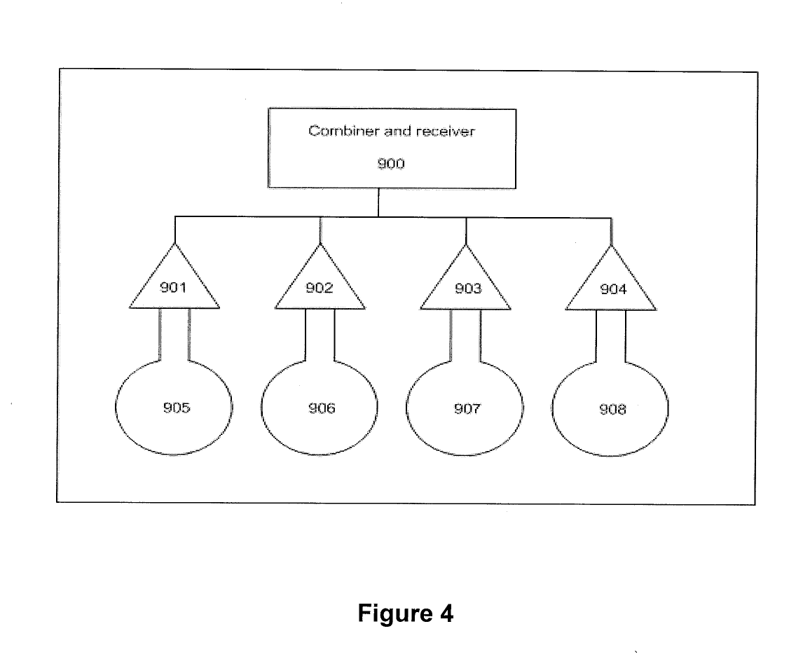

FIG. 4 shows a system of multiple antennas 905, 906, 907 and 908, each connected to a receive amplifier 901, 902, 903 and 904 illustrated in schematic form. The receive amplifier outputs are combined by the combiner and receiver 900. This system can be used to combine the received signals from the multiple antenna systems described in this application.

For underwater applications, the antenna of the present invention is preferably an electrically insulated magnetic coupled antenna. Electrically insulated magnetic coupled antennas are ideal for use in communication systems in an underwater environment they are more efficient than electrically coupled antennas. Underwater attenuation is largely due to the effect of conduction on the electric field. Since electrically coupled antennas produce a higher electric field component, in water in the near field, the radiated signal experiences higher attenuation. In comparison a magnetic loop antenna produces strong magneto-inductive field terms in addition to the electromagnetic propagating field. The magneto-inductive terms are greater than the propagating field close to the transmitting antenna and provide an additional means for coupling a signal between two antennas. For both shorter and greater distances, magnetic coupled antennas are more efficient under water than electrically coupled. In applications where long distance transmission is required, the magnetic antenna should preferably be used at lowest achievable signal frequency. This is because signal attenuation in water increases as a function of increasing frequency. Hence, minimising the carrier frequency where possible allows the transmission distance to be maximised. In practice, the lowest achievable signal frequency will be a function of the desired bit rate and the required distance of transmission

A skilled person will appreciate that variations of the disclosed example arrangements are possible without departing from the essence of this invention. For example, although usually the smallest number of turns in a sub-loop will be just one, a sub-loop also can be considered to be of less than one complete turn, so that more than one driver is deployed within one complete turn of the antenna loop. Alternatively or additionally the number of loops may be any number greater than 2. Also the sub-loops may not be closely spaced, aligned in axis or completely coupled.

The currents in the sub-loops may not necessarily be equal and do not have to be exactly in phase. Also, the number of turns in the sub-loops may be different and the magnetic moment may be enhanced by the introduction of ferromagnetic core material within the loop. Furthermore, in those applications of this transmitting antenna that require a receiving function, the antenna loops also may be used conveniently and advantageously as an electromagnetic or magneto-electric receive antenna. Applications of this invention are not limited to communication systems but may also include others requiring a large alternating magnetic moment. These include but are not limited to navigation systems, direction finding systems and systems for detecting the presence of objects.

1. A magnetic and/or magneto-electric antenna that has a plurality of conducting loops, two or more of the loops being driven by separate drivers.

2. An antenna as claimed in claim 1 wherein every loop is driven by a separate driver.

3. An antenna as claimed in claim 1 wherein two or more groups of loops are driven by separate drivers.

4. An antenna as claimed in any of the preceding claims wherein each loop is centred about a common axis, and displaced along that axis.

5. An antenna as claimed in any of the preceding claims wherein the loops are used singly or in combination to receive a signal.

6. An antenna as claimed in claim 5 wherein the signal received from each loop is combined substantially in phase.

7. An antenna as claimed in any of the preceding claims wherein the conductor loops are in close proximity and/or closely coupled.

8. An antenna as claimed in any of the preceding claims wherein the loops are used singly or in combination to transmit signal currents.

9. An antenna as claimed in claim 8, wherein the transmit signal in each loop is arranged to be substantially in phase mutually.

10. An antenna as claimed in any of the preceding claims wherein the output of one or more of the driver circuits is electrical voltage.

11. An antenna as claimed in any of the preceding claims wherein a high permeability core material passes through the centre of the loops

12. An antenna as claimed in any of the preceding claims wherein the output of one or more driver circuit is an electrical current.

13. An antenna as claimed in any of the preceding claims wherein one or more of the driver circuits is a source with an impedance that has real and/or imaginary parts.

14. An antenna as claimed in any of the preceding claims incorporated in a communications system.

15. An antenna as claimed in any of the preceding claims incorporated in a navigation system or a direction finding system or a system for detecting the presence of objects or any combination of these.
